(19) United States
(12) Patent Application Publication
(10) Pub. No.: US 2022/0110819 A1
(43) Pub. Date: Apr. 14, 2022

(54) PISTON SUCKING-TYPE MASSAGER

(71) Applicants: Xuebin Guo, Dongguan (CN); Changzhi Luo, Dongguan (CN)

(72) Inventors: Xuebin Guo, Dongguan (CN); Changzhi Luo, Dongguan (CN)

(21) Appl. No.: 17/560,296

(22) Filed: Dec. 23, 2021

(30) Foreign Application Priority Data
Aug. 20, 2021 (CN) 202110960628.6

(51) Int. Cl. A61H 9/00

(52) U.S. Cl. CPC A61H 9/0057; A61H 2201/149; A61H 2201/1215

(57) ABSTRACT

In a piston sucking-type massager disclosed in the present invention, a massage port of a straight-cylinder piston chamber is in contact with the human skin and then closed, a push-pull driving device drives a push-pull member to reciprocate and translate linearly, and a piston follows the action of the push-pull member to reciprocate and translate linearly in the straight-cylinder piston chamber, so that positive and negative pressures are formed in a space between the manage port of the straight-cylinder piston chamber and one end surface of the piston, for sucking massage.

### TECHNICAL FIELD

The present invention relates to the field of healthcare equipment technologies, and in particular, to a piston sucking-type massager.

### RELATED ART

With the accelerating pace of life, people have increasingly large work pressures. In order to complete work tasks, people often work overtime. After a hard day at work, the body of a human becomes tired. In order to relieve fatigue and maintain physical and mental health, a massager, such as a negative pressure massager, is generally used to massage the body. The negative pressure massager relieves fatigue and soreness by adsorbing and relaxing the skin, so as to achieve the purpose of soothing the body and mind. However, the adsorbing effect of the negative pressure massager in the related art is not desirable, resulting in a poor massage effect.

Therefore, it is necessary to improve the existing negative pressure massager to avoid the above defects.

### SUMMARY

A purpose of the present invention is to design a piston sucking-type massager for solving the above technical deficiencies, and the specific arrangement is as follows.

A piston sucking-type massager designed in the present invention includes a control unit, a power supply device, at least one piston cylinder, at least one piston, and a push-pull driving device, wherein the power supply device is connected to the push-pull driving device through the control unit, the push-pull driving device includes a push-pull member, the piston cylinder includes a straight-cylinder piston chamber, the piston is placed in the straight-cylinder piston chamber, and at least a part of an outer peripheral side wall of the piston fits a wall of the straight-cylinder piston chamber; when a massage port of the straight-cylinder piston chamber is in contact with the human skin and then closed, the push-pull driving device drives the push-pull member to reciprocate and translate linearly, and the piston follows the action of the push-pull member to reciprocate and translate linearly in the straight-cylinder piston chamber, so that positive and negative pressures are formed in a space between the massage port of the straight-cylinder piston chamber and one end surface of the piston, for sucking massage.

After the above massage, the human body does not need to be massaged by another person, and the function of self-massage is realized by electric drive; therefore, there is no labor cost, it is convenient to carry, and massage may be performed anytime and anywhere, which improves the convenience of massage. The port of the piston cylinder may fit various body parts of the human body. When the piston reciprocates, upward and downward airflows are generated to realize the sucking function to the body parts, which promotes the blood circulation of the massaged point, increases the irritation during massage, and improves the effect of relieving the muscles and relaxing the body through massage.

Preferably, the push-pull driving device further includes a first drive motor and a rotating member, the rotating member includes an eccentric part, the push-pull member includes a first push-pull rod, one end of the first push-pull rod is connected to the other end surface of the piston, and a rotating shaft on at least one end of the first drive motor is provided with the rotating member, the first push-pull rod is rotatably connected to the eccentric part, and the power supply device is connected to the first drive motor through the control unit.

Preferably, the rotating member includes a driving gear and several driven gears, and the rotating shaft on at least one end of the first drive motor is provided with the driving gear, the driving gear is engaged with the driven gears, and the eccentric part is arranged on the driven gears.

Preferably, the rotating member includes a worm gear and a worm that are mutually engaged for transmission, the worm is installed on the rotating shaft on at least one end of the first drive motor, and the eccentric part is arranged on the worm gear.

Preferably, the piston includes a rigid connecting member and a first flexible sleeve sleeved on the rigid connecting member, and one end of the first push-pull rod is connected to the rigid connecting member.

Preferably, the rigid connecting member includes a connecting cavity, a connecting rod is arranged on a wall of the connecting cavity, and one end of the first push-pull rod is inserted into the connecting cavity and then rotatably connected to the connecting rod; or

the rigid connecting member includes a connecting part, one end of the first push-pull rod is provided with a connecting cavity, a connecting rod is arranged on a wall of the connecting cavity, and the connecting part is rotatably connected to the connecting rod.

Preferably, at least a part of an outer peripheral side of the first flexible sleeve is provided with a first skirt, and the first skirt fits a wall of the straight-cylinder piston chamber.

Preferably, the piston includes a first flexible body, the first flexible body includes a spherical cavity, one end of the first push-pull rod is provided with a ball, and the ball is placed in the spherical cavity.

Preferably, at least a part of the outer peripheral side of the first flexible body is provided with a second skirt, and the second skirt fits the wall of the straight-cylinder piston chamber.

Preferably, the piston includes a second flexible body, one end of the first push-pull rod is provided with a spring, and an end portion of the spring is connected to the other end surface of the second flexible body.

Preferably, at least a part of an outer peripheral side of the second flexible body is provided with a third skirt, and the third skirt fits the wall of the straight-cylinder piston chamber.

Preferably, the push-pull driving device includes a conductive coil wound on the piston cylinder and a magnet fixed in the piston, the conductive coil is connected to the power supply device, and the power supply device is connected to the conductive coil through the control unit.

Preferably, the push-pull driving device includes a second drive motor and a rotating sleeve, the push-pull member includes a reciprocating screw or screw, the reciprocating screw or screw is placed in an inner hole of the rotating sleeve, the rotating sleeve is fixedly connected to a rotating shaft on a second drive motor, a guide rod is rotatably installed on an inner hole wall of the rotating sleeve, the guide rod is placed in a spiral slot of the reciprocating screw or screw, and the piston is installed on the reciprocating screw or screw; or

the push-pull driving device includes a second drive motor and a rotating sleeve, the push-pull member includes a telescopic rod, the telescopic rod is provided with an inclined guide slot, the telescopic rod is placed in an inner hole of the rotating sleeve, the rotating sleeve is fixedly connected to a rotating shaft on the second drive motor, a guide rod is rotatably installed on an inner hole wall of the rotating sleeve, the guide rod is placed in the inclined guide slot, and the piston is installed on the telescopic rod; and

the power supply device is connected to the second drive motor through the control unit.

Preferably, the piston includes a second flexible sleeve and a fixing member arranged on the reciprocating screw or screw or the telescopic rod, and the second flexible sleeve is sleeved and fixed on the fixing member.

Preferably, at least a part of an outer peripheral side of the second flexible sleeve is provided with a fourth skirt, and the fourth skirt fits the wall of the straight-cylinder piston chamber.

The piston sucking-type massager designed by the present invention uses a push-pull driving device to drive a piston to reciprocate and translate, so that positive and negative pressures can be formed in a space between a massage port of a straight-cylinder piston chamber and one end surface of the piston, for absorbing and relaxing the skin to achieve a sucking massage, so that the massage effect is desirable.

### BRIEF DESCRIPTION OF THE DRAWINGS

FIG. 1 is a schematic structural diagram (1) of only a single rotating member installed on a first drive motor;

FIG. 2 is a schematic structural diagram (2) of only a single rotating member installed on a first drive moto;

FIG. 3 is a schematic structural diagram of a massager in which a first push-pull rod is driven to act by double shafts;

FIG. 4 is a schematic structural diagram of a massager having two massage stations;

FIG. 5 is a schematic structural diagram of a gear-driven massager with a shell;

FIG. 6 is an exploded diagram of a gear-driven massager;

FIG. 7 is a schematic structural diagram of a gear-driven massager in which a first push-pull rod is driven to act by double shafts;

FIG. 8 is a schematic structural diagram of a gear-driven massager having two massage stations;

FIG. 9 is a schematic structural diagram (1) of a worm and gear-driven massager;

FIG. 10 is a schematic structural diagram (2) of a worm and gear-driven massager;

FIG. 11 is an exploded structural diagram of a piston;

FIG. 12 is a piston structure (1) with an O-ring;

FIG. 13 is a piston structure (2) with an O-ring;

FIG. 14 is a connecting structure (1) of a piston and a first push-pull rod;

FIG. 15 is a connecting structure (2) of a piston and a first push-pull rod;

FIG. 16 is a connecting structure (3) of a piston and a first push-pull rod;

FIG. 17 is a connecting structure (4) of a piston and a first push-pull rod;

FIG. 18 is a connecting structure (5) of a piston and a first push-pull rod;

FIG. 19 is a connecting structure (6) of a piston and a first push-pull rod;

FIG. 20 is a schematic structural diagram (1) of another push-pull driving device;

FIG. 21 is a schematic structural diagram (2) of another push-pull driving device;

FIG. 22 is a schematic structural diagram (1) of still another push-pull driving device;

FIG. 23 is a schematic structural diagram (2) of still another push-pull driving device; and

FIG. 24 is a schematic structural diagram (3) of still another push-pull driving device.

### DETAILED DESCRIPTION

The technical solutions in the embodiments of the present invention will be dearly and completely described below with reference to the accompanying drawings in the embodiments of the present invention. Obviously, the described embodiments are only a part of the embodiments of the present invention, rather than all the embodiments. Based on the embodiments of the present invention, all other embodiments obtained by those of ordinary skill in the art fall within the protection scope of the present invention.

### Embodiment

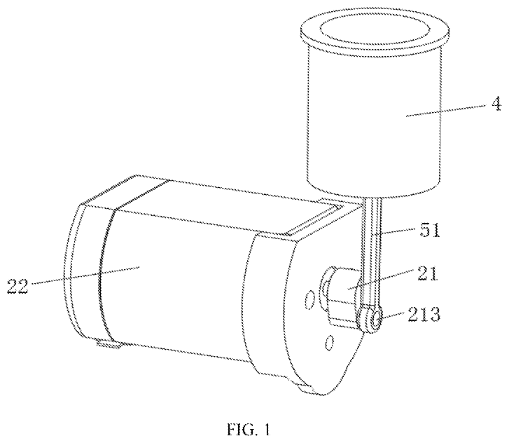

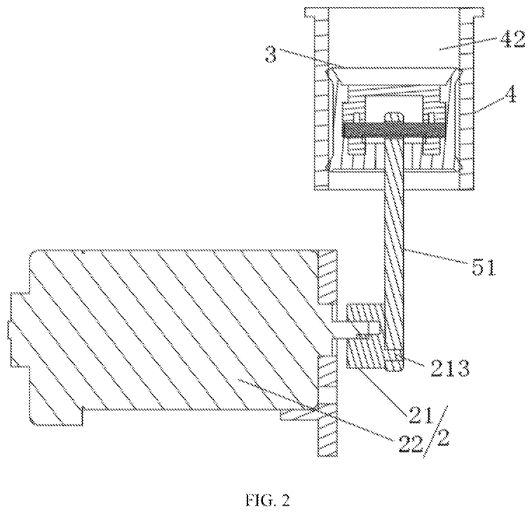

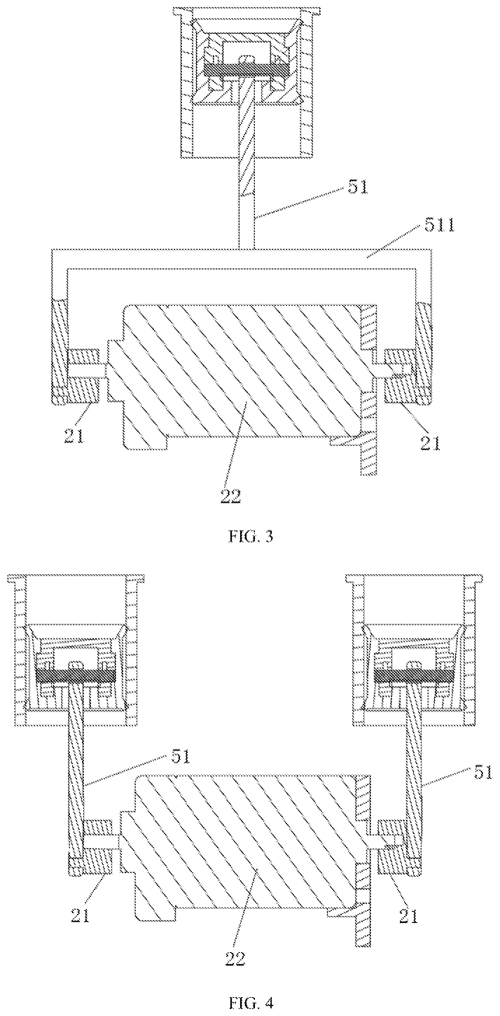

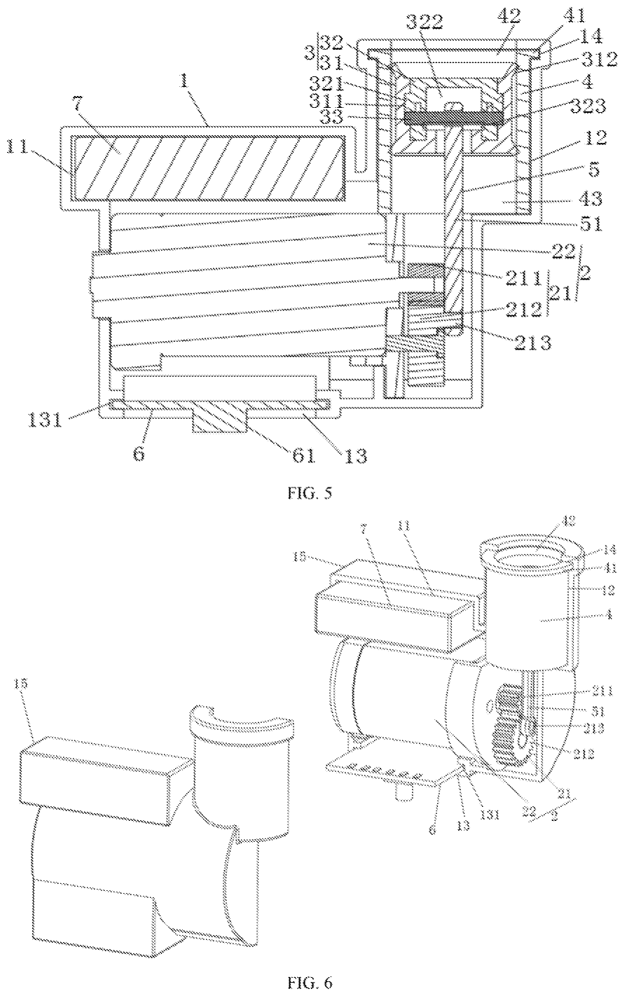

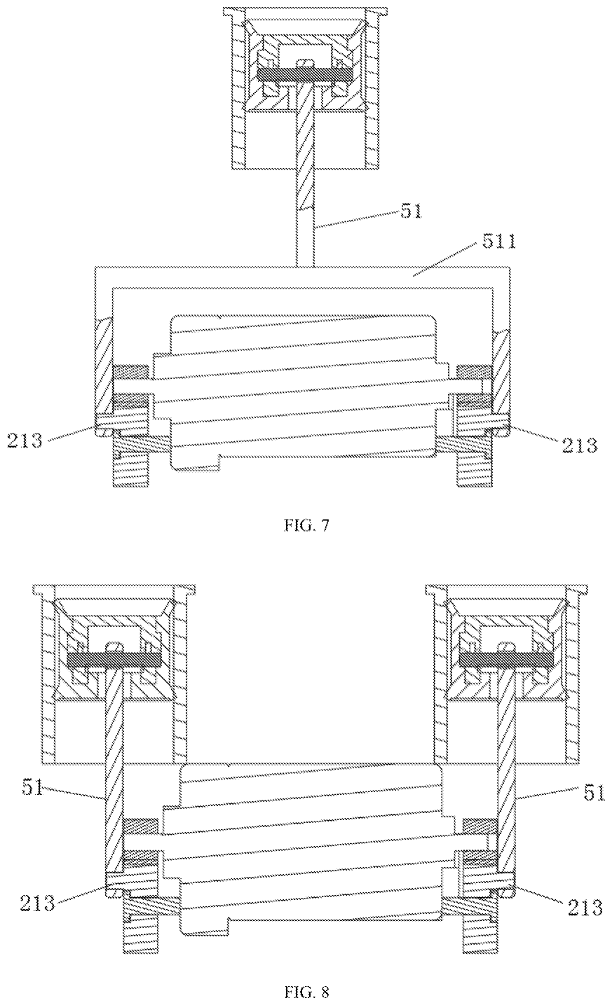

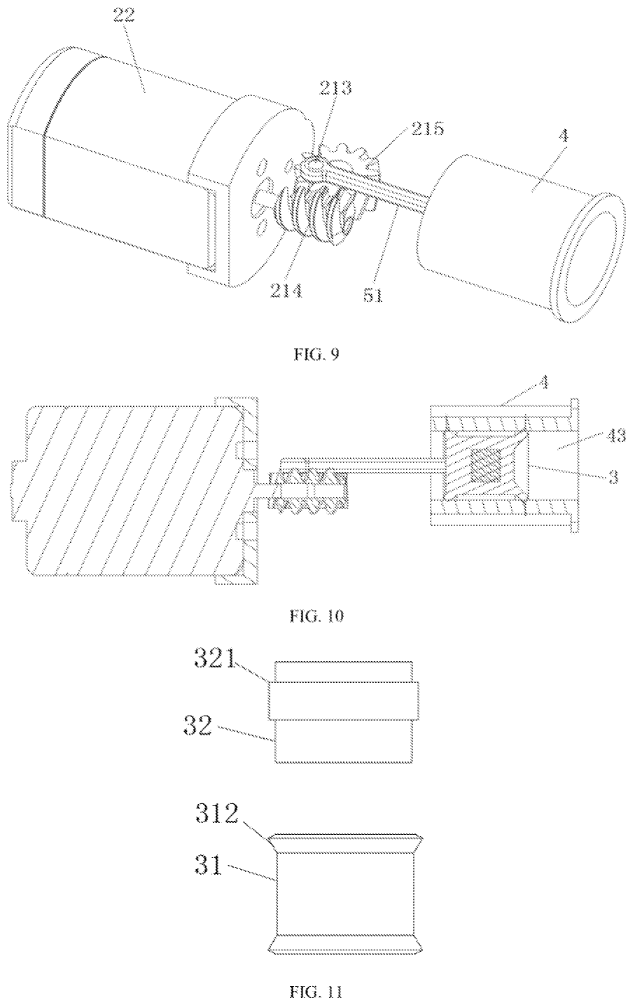

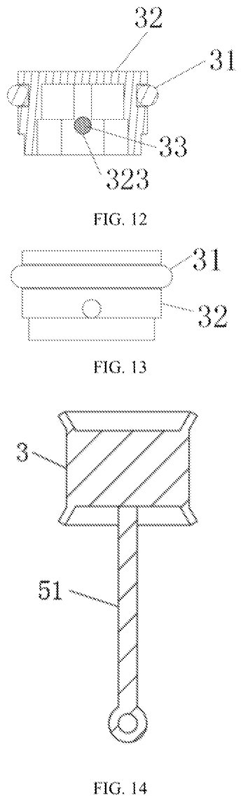

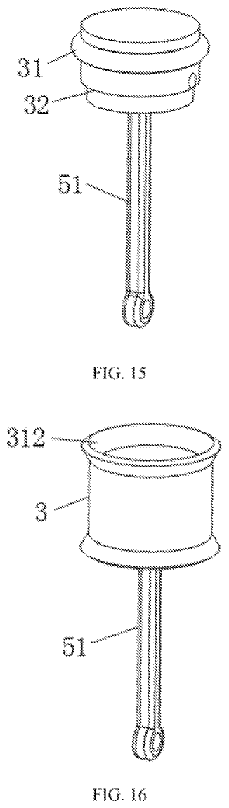

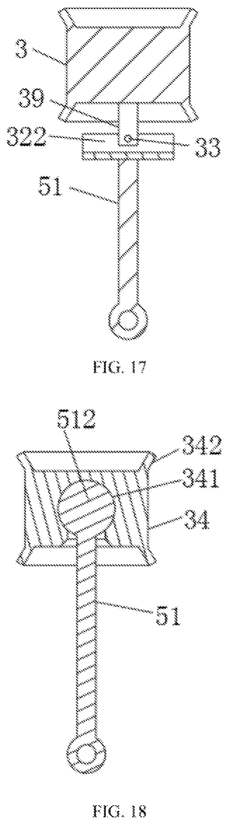

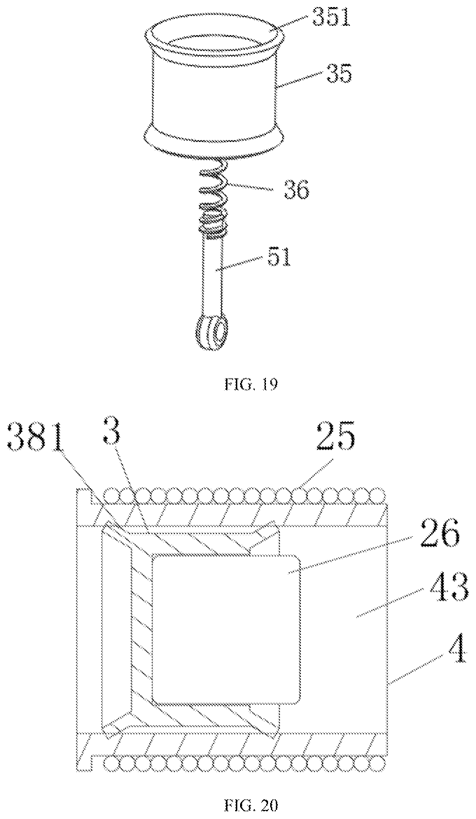

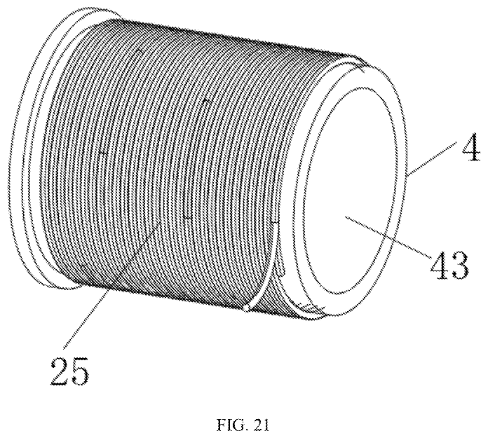

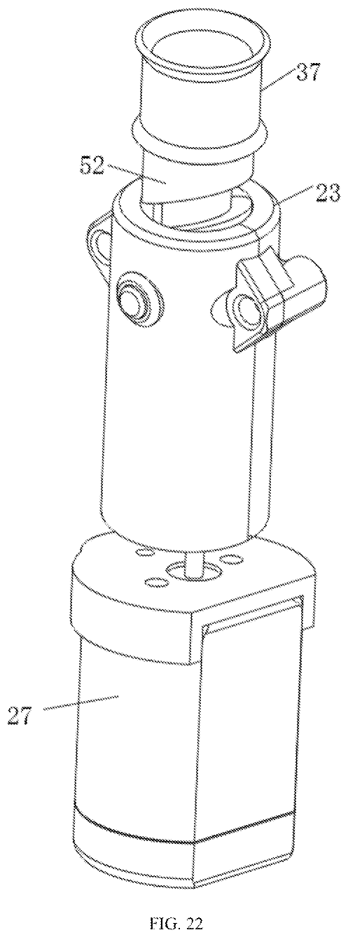

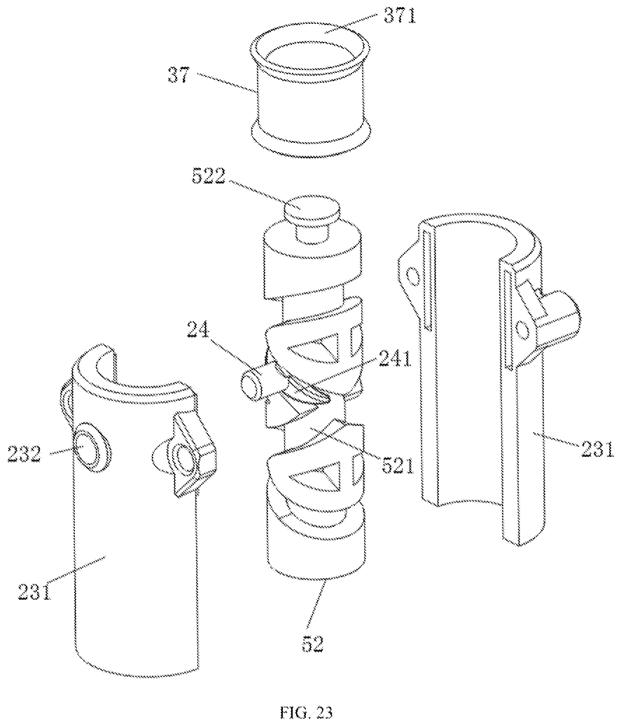

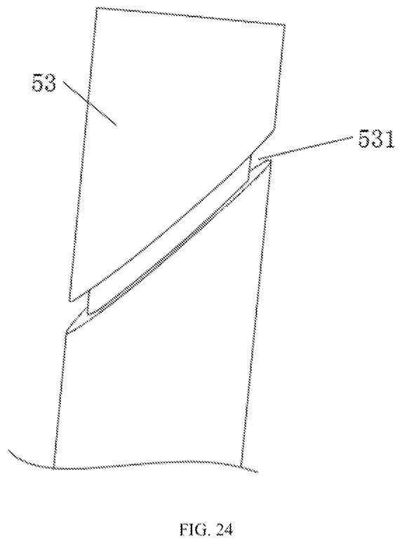

As shown in FIG. 1, a piston sucking-type massager described in the present embodiment includes a control unit 6, a power supply device 7, at least one piston cylinder 4, at least one piston 3, and a push-pull driving device 2. The power supply device 7 is connected to the push-pull driving device 2 through the control unit 6. The push-pull driving device 2 includes a push-pull member 5. The piston cylinder 4 includes a straight-cylinder piston chamber 43. The piston 3 is placed in the straight-cylinder piston chamber 43. At least a part of an outer peripheral side wall of the piston fits a wall of the straight-cylinder piston chamber 43. When a massage port 42 of the straight-cylinder piston chamber 43 is in contact with the human skin and then closed, the push-pull driving device 2 drives the push-pull member 5 to reciprocate and translate linearly, and the piston 3 follows the action of the push-pull member 5 to reciprocate and translate linearly in the straight-cylinder piston chamber 43, so that positive and negative pressures are formed in a space between the massage port of the straight-cylinder piston chamber 43 and one end surface of the piston 3, for sucking massage. During the massage, the skin is absorbed and relaxed. The power supply device 7 may be a lithium battery or an external power supply. The control unit 6, the power supply device 7, the piston cylinder 4, and the push-pull driving device 2 are all placed in a shell 1. The power supply device 7 and the piston cylinder 4 are respectively positioned and installed in a first positioning cavity 11 and a second positioning cavity 12 in the shell 1. The control unit 6 is arranged at an opening 13 of the shell 1, and a peripheral side of the control unit 6 is embedded in a positioning groove of the opening 13. In order that the control unit 6, the power supply device 7, the piston cylinder 4, and the push-pull driving device 2 are easily installed in the shell 1, the shell 1 is composed of two half-shells 15 arranged symmetrically, and the two half-shells 15 are fixed by bolts or by welding. The half-shells generally use a plastic material.

Preferably, a locking slot 14 is arranged on an inner wall of the second positioning cavity 12, a locking protrusion 41 is arranged on the piston cylinder 4, and the locking protrusion 41 is correspondingly locked into the locking slot 14, so that the piston cylinder 4 is positioned and installed more stably. A mouth portion of the second positioning cavity 12 corresponds to the massage port 42 of the piston cylinder.

In the present embodiment, the push-pull driving device 2 further includes a first drive motor 22 and at least one rotating member 21. The rotating member 21 includes an eccentric part 211. The push-pull member 5 includes a first push-pull rod 51. One end of the first push-pull rod 51 is connected to the other end surface of the piston 3, the rotating member 21 is installed on a rotating shaft on at least one end of the first drive motor 22, the first push-pull rod 51 is rotatably connected to the eccentric part 211, and the power supply device 7 is connected to the first drive motor 22 through the control unit 6. The control unit 6 adopts a button board, and the button board has a control button 61. When the control button is closed, the power supply device 7 is caused to supply power to the first drive motor 22. The first push-pull rod 51 and the piston 3 may be of an integrated structure, the first drive motor 22 drives the rotating member 21 to rotate, so that the eccentric part 211 makes a circular motion, thus implementing the first push-pull rod 51 pushing and pulling the piston 3 to cause the piston 3 reciprocate and translate linearly in the straight-cylinder piston chamber 43.

Rotating members 21 are respectively installed on rotating shafts at two ends of the drive motor. Two ends of a connecting rod at a lower end of the first push-pull rod 51 are rotatably connected to eccentric parts 211 of the two rotating members 21, for implementing dual-shaft driving, and improving the drive force to the piston 3. Alternatively, there are two first push-pull rods 51, two piston cylinders 4, and two pistons 3 arranged to increase the massage station.

For a preferred manner of arranging the rotating member 21, the rotating member 21 includes a driving gear 211 and several driven gears. The driving gear 211 is installed on the rotating shaft on at least one end of the first drive motor 22, and the driving gear 211 is engaged with the driven gears. The eccentric part 211 is arranged on the driven gears. The eccentric part 211 is driven to make a circular motion through gear transmission. Generally, one driven gear is used, but in order to have a compact structure and a larger transmission ratio, multiple driven gears engaged with each other may be arranged, and the eccentric part 211 is arranged on the driven gear at a transmission end point.

For another preferred manner of arranging the rotating member 2, the rotating member 21 includes a worm gear 215 and a worm 214 that are engaged with each other for transmission. The worm 214 is installed on the rotating shaft on at least one end of the first drive motor 22, and the eccentric part 211 is arranged on the worm gear 215. The eccentric part 211 is driven to make a circular motion through the transmission of the worm gear 215 and the worm 214.

For a preferred manner of arranging the piston 3, the piston 3 includes a rigid connecting member 32 and a first flexible sleeve 31 sleeved on the rigid connecting member 32. One end of the first push-pull rod 51 is connected to the rigid connecting member 32. One end of the first push-pull rod 51 and the rigid connecting member 32 may be of an integrated structure, or may be rotatably connected through a connecting rod 33. The first flexible sleeve 31 is made of silicone or rubber, and the first flexible sleeve 31 may be of a structure with a closed end or a ring sleeve structure with two penetrating ends, or may be an O-ring. In a case where the first push-pull rod 51 and the rigid connecting member 32 are of an integrated structure, based on a flexible function of the flexible sleeve, the eccentric part 211 is caused to make a circular motion to prompt the first push-pull rod 51 to swing the rigid connecting member 32, and the rigid connecting member 32 swings in the flexible sleeve, so that the piston 3 reciprocates and translates under such conditions. A flange 321 is arranged on a peripheral side of the rigid connecting member 32, a recess 311 is arranged on an inner wall of the first flexible sleeve 31, and the flange 321 is correspondingly embedded in the recess 311 to fix the rigid connecting member 32.

Specifically, the rigid connecting member 32 includes a connecting cavity 322, a wall of the connecting cavity 322 is provided with the connecting rod 33, one end of the first push-pull rod 51 is inserted into the connecting cavity 322 and then rotatably connected to the connecting rod 33. Alternatively, the rigid connecting member 32 includes a connecting part 39, one end of the first push-pull rod 51 is provided with a connecting cavity 322, a wall of the connecting cavity 322 is provided with the connecting rod 33, and the connecting part 39 is rotatably connected to the connecting rod 33. The rotatably connected structure may be selected and used according to actual situations, and two ends of the connecting rod 33 are fixed in two opposite fixing holes 323 on an inner wall of the connecting cavity 322 by interference fitting.

Preferably, at least a part of an outer peripheral side of the first flexible sleeve 31 is provided with a first skirt 312, the first skirt 312 fits the wall of the straight-cylinder piston chamber 43, and the skirt is arranged to avoid full contact between the outer wall of the first flexible body 31 and the inner wall of the straight-cylinder piston chamber 43, thereby reducing a contact area and improving the smoothness of the movement of the piston 3 in the straight-cylinder piston chamber 43.

For another preferred manner of arranging the piston 3, the piston 3 includes a first flexible body 34, the first flexible body 34 includes a spherical cavity 341, one end of the first push-pull rod 51 is provided with a ball 512, and the ball 512 is placed in the spherical cavity 341. The first flexible body 34 is made of silicone or rubber, and its structure enables the first push-pull rod 51 to be movably connected to the first flexible body 34 to prevent the piston 3 from swinging during reciprocation and translation.

Preferably, at least a part of the outer peripheral side of the first flexible body 34 is provided with a second skirt 342, and the second skirt 342 fits the wall of the straight-cylinder piston chamber 43. The skirt is arranged to avoid full contact between the outer wall of the first flexible body 34 and the inner wall of the straight-cylinder piston chamber 43, thereby reducing a contact area and improving the smoothness of movement of the piston 3 in the straight-cylinder piston chamber 43.

For another preferred manner of arranging the piston 3, the piston 3 includes a second flexible body 35, one end of the first push-pull rod 51 is provided with a spring 36, and an end portion of the spring 36 is connected to the other end surface of the second flexible body 35. The second flexible body 35 is made of silicone or rubber. One end portion of the spring 36 may be screwed to a connecting hole of the second flexible body 35, so that one end portion of the spring 36 is placed in a cavity of the second flexible body 35, and the spring 36 is fixed to the second flexible body 35. Alternatively, one end portion of the spring 36 is encapsulated and fixed to the second flexible body 35. The end portion of the spring 36 and the end portion of the first push-pull rod 51 are fixed by welding. Both the spring 36 and the first push-pull rod 51 may be made of metal or plastic materials.

Preferably, at least a part of an outer peripheral side of the second flexible body 35 is provided with a third skirt 351, and the third skirt 351 fits the wall of the straight-cylinder piston chamber 43. The skirt is arranged to avoid full contact between the outer wall of the second flexible body 35 and the inner wall of the straight-cylinder piston chamber 43, thereby reducing a contact area and improving the smoothness of the movement of the piston 3 in the straight-cylinder piston chamber 43.

In another embodiment, the push-pull driving device 2 includes a conductive coil 25 wound on the piston cylinder 4 and a magnet 26 fixed in the piston 3. The conductive coil 25 is connected to the power supply device 7, and the power supply device 7 is connected to the conductive coil 25 through the control unit 6. The power supply device 7 inputs current to the conductive coil 25 through the control unit 6 to cause the conductive coil 25 to generate a magnetic field. The control unit 6 is a circuit that can automatically control the direction of the current to periodically change, and the circuit is a conventionally known technical means, and will not be detailed here. Therefore, the current input to the conductive coil 25 is controlled to change periodically, thereby changing the direction of the magnetic field. According to the electromagnetic principle of repulsion of different polarities and attraction of like polarities, the moving magnet 26 is driven to reciprocate, thereby driving the piston 3 to reciprocate. The piston 3 is a rubber sleeve or a silicone sleeve, and an outer peripheral side wall is provided with a convex ring. The convex ring fits the straight-cylinder piston chamber 43, and the magnet 26 is fixed in the rubber sleeve or silicone sleeve by interference fitting.

In another embodiment, the push-pull driving device 2 includes a second drive motor 27 and a rotating sleeve 23. The push-pull member 5 includes a reciprocating screw 52 or screw. The reciprocating screw 52 or screw is placed in an inner hole of the rotating sleeve 23, and the rotating sleeve 23 is fixedly connected to a rotating shaft on the second drive motor 27. A guide rod 24 is rotatably installed on an inner hole wall of the rotating sleeve 23, and the guide rod 24 is placed in a spiral slot 521 of the reciprocating screw 52 or screw. The piston 3 is installed on the reciprocating screw 52 or screw, where the spiral slot 521 on the screw is a single spiral slot.

Alternatively, the push-pull driving device 2 includes a second drive motor 27 and a rotating sleeve 23. The push-pull member 5 includes a telescopic rod 53, and the telescopic rod is provided with an inclined guide slot 531. The telescopic rod 53 is placed in an inner hole of the rotating sleeve 23. The rotating sleeve 23 is fixedly connected to a rotating shaft on the second drive motor 27, a guide rod 24 is rotatably installed on an inner hole wall of the rotating sleeve 23, the guide rod 24 is placed in the inclined guide slot 531, and the piston 3 is installed on the telescopic rod 53. The inclined guide slot 531 preferentially adopts an inclined guide slot 531 of an annular structure.

The power supply device 7 is connected to the second drive motor 27 through the control unit 6.

Specifically, the rotating sleeve 23 includes two semicircular shells 231 arranged symmetrically, and the two semicircular shells 231 are symmetrically assembled with each other and then fixed by bolts. Moreover, one of the semicircular shells is provided with a circular hole 232, one end of the guide rod 24 is inserted into the circular hole 232, the other end of the guide rod 24 is provided with an arc-shaped guide member 241, and the arc-shaped guide member is placed in the inclined guide slot 531 or the spiral slot 521. When the rotating sleeve 23 is driven to rotate by the second drive motor 27, the arc-shaped guide member 241 travels along a trajectory of the inclined guide slot 531 or the spiral slot 521 so as to realize the push-pull action of the reciprocating screw 52 or screw or the telescopic rod 53, thereby driving the piston 3 to reciprocate and translate in the straight-cylinder piston chamber 43.

Preferably, the piston 3 includes a second flexible sleeve 37 and a fixing member 522 arranged on the reciprocating screw 52 or screw or the telescopic rod 53. The second flexible sleeve 37 is sleeved and fixed on the fixing member 522. The second flexible sleeve 37 may be of a structure with a closed end or a ring sleeve structure with two penetrating ends, or may be an O-ring.

Preferably, the fixing member 522 may be a T-shaped rod, and a matching inner cavity of the second flexible sleeve 37 is a T-shaped cavity, thereby fixing the second flexible sleeve 37.

Preferably, at least a part of the outer peripheral side of the second flexible sleeve 37 is provided with a fourth skirt 371, and the fourth skirt 371 fits the wall of the straight-cylinder piston chamber 43. The skirt is provided to avoid full contact between the outer wall of the second flexible body 37 and the inner wall of the straight-cylinder piston chamber 43, thereby reducing a contact area and improving the smoothness of the movement of the piston 3 in the straight-cylinder piston chamber 43.

The present invention is not limited to the above preferred embodiment. Anyone can derive other products in various forms under the enlightenment of the present invention, but regardless of any changes in its shape or structure, any products having technical solutions the same as or similar to those of the present application shall fall within the protection scope of the present invention.

What is claimed is:

1. A piston sucking-type massager, characterized by comprising control unit (6), power supply device (7), at least one piston cylinder (4), at least one piston (3), and push-pull driving device (2), wherein power supply device (7) is connected to push-pull driving device (2) through control unit (6), push-pull driving device (2) comprises push-pull member (5), piston cylinder (4) comprises straight-cylinder piston chamber (43), piston (3) is placed in straight-cylinder piston chamber (43), and at least a part of an outer peripheral side wall of piston (3) fits a wall of straight-cylinder piston chamber (43); when a massage port of straight-cylinder piston chamber (43) is in contact with the human skin and then closed, push-pull driving device (2) drives push-pull member (5) to reciprocate and translate linearly, and piston (3) follows the action of push-pull member (5) to reciprocate and translate linearly in straight-cylinder piston chamber (43), so that positive and negative pressures are formed in a space between the massage port of straight-cylinder piston chamber (43) and one end surface of piston (3), for sucking massage.

2. The piston sucking-type massager according to claim 1, characterized in that push-pull driving device (2) further comprises first drive motor (22) and rotating member (21), and rotating member (21) comprises eccentric part (211), push-pull member (5) comprises first push-pull rod (51), one end of first push-pull rod (51) is connected to the other end surface of piston (3), and a rotating shaft on at least one end of first drive motor (22) is provided with rotating member (21), first push-pull rod (51) is rotatably connected to eccentric part (211), and power supply device (7) is connected to first drive motor (22) through control unit (6).

3. The piston sucking-type massager according to claim 2, characterized in that rotating member (21) comprises driving gear (211) and several driven gears, and the rotating shaft on at least one end of first drive motor (22) is provided with driving gear (211), driving gear (211) is engaged with the driven gears, and eccentric part (211) is arranged on the driven gears.

4. The piston sucking-type massager according to claim 2, characterized in that rotating member (21) comprises worm gear (215) and worm (214) that are mutually engaged for transmission, worm (214) is installed on the rotating shaft on at least one end of first drive motor (22), and eccentric part (211) is arranged on worm gear (215).

5. The piston sucking-type massager according to claim 3, characterized in that piston (3) comprises rigid connecting member (32) and first flexible sleeve (31) sleeved on rigid connecting member (32), and one end of first push-pull rod (51) is connected to rigid connecting member (32).

6. The piston sucking-type massager according to claim 5, characterized in that rigid connecting member (32) comprises connecting cavity (322), connecting rod (33) is arranged on a wall of connecting cavity (322), and one end of first push-pull rod (51) is inserted into connecting cavity (322) and then rotatably connected to connecting rod (33); or
rigid connecting member (32) comprises connecting part (39), one end of first push-pull rod (51) is provided with connecting cavity (322), connecting rod (33) is arranged on a wall of connecting cavity (322), and connecting part (39) is rotatably connected to connecting rod (33).

7. The piston sucking-type massager according to claim 5, characterized in that at least a part of an outer peripheral side of first flexible sleeve (31) is provided with first skirt (312), and first skirt (312) fits a wall of straight-cylinder piston chamber (43).

8. The piston sucking-type massager according to claim 3, characterized in that piston (3) comprises first flexible body (34), first flexible body (34) comprises spherical cavity (341), one end of first push-pull rod (51) is provided with ball (512), and ball (512) is placed in spherical cavity (341).

9. The piston sucking-type massager according to claim 8, characterized in that at least a part of the outer peripheral side of first flexible body (34) is provided with second skirt (342), and second skirt (342) fits the wall of straight-cylinder piston chamber (43).

10. The piston sucking-type massager according to claim 3, characterized in that piston (3) comprises second flexible body (35), one end of the first push-pull rod (51) is provided with spring (36), and an end portion of spring (36) is connected to the other end surface of second flexible body (35).

11. The piston sucking-type massager according to claim 10, characterized in that at least a part of an outer peripheral side of second flexible body (35) is provided with third skirt (351), and third skirt (351) fits the wall of straight-cylinder piston chamber (43).

12. The piston sucking-type massager according to claim 1, characterized in that push-pull driving device (2) comprises conductive coil (25) wound on piston cylinder (4) and magnet (26) fixed in piston (3), conductive coil (25) is connected to power supply device (7), and power supply device (7) is connected to conductive coil (25) through control unit (6).

13. The piston sucking-type massager according to claim 1, characterized in that push-pull driving device (2) comprises second drive motor (27) and rotating sleeve (23), push-pull member (5) comprises reciprocating screw (52) or screw, reciprocating screw (52) or screw is placed in an inner hole of rotating sleeve (23), rotating sleeve (23) is fixedly connected to a rotating shaft on second drive motor (27), guide rod (24) is rotatably installed on an inner hole wall of rotating sleeve (23), guide rod (24) is placed m spiral slot (521) of reciprocating screw (52) or screw, and piston (3) is installed on reciprocating screw (52) or screw; or
push-pull driving device (2) comprises second drive motor (27) and rotating sleeve (23), push-pull member (5) comprises telescopic rod (53), telescopic rod (53) is provided with inclined guide slot (531), telescopic rod (53) is placed in an inner hole of rotating sleeve (23), rotating sleeve (23) is fixedly connected to a rotating shaft on second drive motor (27), guide rod (24) is rotatably installed on an inner hole wall of rotating sleeve (23), guide rod (24) is placed in inclined guide slot (531), and piston (3) is installed on telescopic rod (53); and
power supply device (7) is connected to second drive motor (27) through control unit (6).

14. The piston sucking-type massager according to claim 13, characterized in that piston (3) comprises second flexible sleeve (37) and fixing member (522) arranged on reciprocating screw (52) or screw or telescopic rod (53), and second flexible sleeve (37) is sleeved and fixed on fixing member (522).

15. The piston sucking-type massager according to claim 14, characterized in that at least a part of an outer peripheral side of second flexible sleeve (37) is provided with fourth skirt (371), and fourth skirt (371) fits the wall of straight-cylinder piston chamber (43).
